(19) United States
(12) Patent Application Publication
(10) Pub. No.: US 2007/0168918 A1
(43) Pub. Date: Jul. 19, 2007

(54) Software Development Planning and Management System

(75) Inventors: Jeanne Metherall, Doylestown, PA (US); Philip DiJoseph, Malvern, PA (US); Nicholas Conti, Spring City, PA (US); Catherine Britton, Media, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/558,635

(22) Filed: Nov. 10, 2006

Related U.S. Application Data
(60) Provisional application No. 60/735,682, filed on Nov. 10, 2005.

(51) Int. Cl. G06F 9/44

(52) U.S. Cl. 717/101

(57) ABSTRACT

A software development planning and management system includes at least one repository of information associating, sub-tasks of an encompassing software development task to be completed and a timeline of sub-task completion, programmer personnel resources, software development requirements and software defects. A user interface uses the repository in providing data representing at least one display image indicating status of sub-task completion, including status of sub-task software generation and test. A resource processor also uses the repository in determining programmer personnel resources required for completion of a plurality of sub-tasks.

The present patent application derives priority from U.S. Provisional Patent Application Ser. No. 60/735,682, filed on Nov. 10, 2005.

### FIELD OF THE INVENTION

The present invention relates generally to the field of data processing, and more particular to data processing tools used to perform software project and requirements management functions.

### BACKGROUND OF THE INVENTION

Tools exist to assist in the planning, management and supervision of software development projects. Existing systems plan and manage complex software development projects using uncoordinated spreadsheets and other tools to monitor the progress of a project. Such systems analyze the overall project plan as the plan relates to two classes of resources, namely, the suppliers and the ultimate consumers. Existing methods are unable to quickly react when one or more factors affecting the project change because the affected interrelationships are not obvious without an extraordinary manual analysis, global project knowledge and senior level expertise. In traditional software development methods a task and outcome are defined prior to the start of coding. Defined processes work well when the inputs to the process can be perfectly defined and there is little complexity, ambiguity or change.

One existing project management technique is known as the Agile software development method introduced by the Agile Software Corporation San Jose, Calif. The Agile software development method is a conceptual framework for undertaking software engineering projects. Most Agile software development methods attempt to minimize project risk by developing software in short time frame chunks, called iterations, which typically last for one to four weeks. An iteration is itself a miniature software project.

An iteration includes the planning, requirements analysis, design, coding, testing, and documentation tasks necessary to release the small increment of new functionality achieved by the iteration. While an iteration may not add enough functionality to warrant releasing the final product, a software project development team that utilizes Agile development methods intends to be capable of releasing new software upon the completion of every iteration. At the end of an iteration, the development team reevaluates project priorities.

Agile development methods emphasize real time communication, preferably in person, over written documents. Most Agile development teams are located in a bullpen environment and include the people necessary to complete the software iteration. At a minimum the bullpen team includes programmers as well as the people who are defining a product. The latter group may be product managers, business analysts or actual product purchasers. The bullpen team may also include testers, interaction designers, technical writers, and managers. Agile development methods emphasize the creation of working software as the primary measure of progress rather than requirements or other system analysis documents. Combined with the preference for face to face communication, Agile methods produce very little written documentation relative to other software development methods.

The Agile development process utilizes several specific terminologies including suppliers, consumers, scrum, and sprint. Suppliers are a class of project development personnel who design, build or test software tasks. Consumers are a class of project development personnel who use the software tasks either as intermediate users or as end users. Intermediate users can become suppliers by adding more features and functionality to the software tasks they have received prior to the task being finally delivered to a consumer. Ultimately the consumer becomes the customer who has requested the feature or function.

A scrum is a specific Agile process for developing software. The scrum process causes projects to progress via a series of typically month long iterations called sprints. The scrum process is suited for projects with rapidly changing or highly emergent requirements. The work to be done on a scrum-based project is listed in the product backlog, which is a list of desired changes to the product. The serum process is an empirical process that uses frequent inspection, daily meetings, collaboration and adaptive responses.

The sprint period is the short, typically thirty day period of software development within the Agile scrum software development process. At the start of a sprint period a sprint planning meeting is held during which the product owner prioritizes the product backlog and a scrum team selects the tasks that they can complete during the upcoming sprint. These tasks are then moved from the product backlog to the sprint backlog. During the sprint period the team holds brief daily meetings to adjust the scope of work, address issues, correct errors, act on new innovation and assess resource capacity. At the end of each sprint period the team demonstrates the completed functionality at a sprint review meeting. If accepted the sprint work product is added to a larger pool of similar sprint results either dedicated to a specific product release or to a group of functions desired by a particular customer.

While the Agile software development protocol may offer advantages over prior methods, a lack of centralized, meaningful and reviewable information can hamper the process. The present invention addresses the problems associated with software development methods that lack traditional documentation protocols. Existing development systems are highly dependent on the expertise of people that necessarily varies with skill level and experience. A need exists for a software development tool that permits developers to view the project both globally across multiple applications and locally within a single application, as well as to view a single sprint within multiple sprints for a single application.

### BRIEF SUMMARY OF THE INVENTION

In accordance with principles of the present invention, a software development planning and management system includes at least one repository of information associating, sub-tasks of an encompassing software development task to be completed and a timeline of sub-task completion, programmer personnel resources, software development requirements and software defects. A user interface uses the repository in providing data representing at least one display image indicating status of sub-task completion, including status of sub-task software generation and test. A resource processor also uses the repository in determining programmer personnel resources required for completion of a plurality of sub-tasks.

### BRIEF DESCRIPTION OF THE DRAWING

In the drawing:

FIG. 1 is a block diagram of a system according to the principles of the present invention;

FIG. 2 is a timeline depicting the operation of a sprint period as utilized by the system according to the present invention depicted in FIG. 1;

FIG. 3 is a block diagram showing the interrelationship of the detect, timeline and software development requirement components depicted in the system according to the present invention FIG. 1;

FIG. 4 is a chart produced by the system according to the present invention depicted in FIG. 1 showing the use of resources expended to build and test the software requirements in relationship to the time needed to complete a software iteration;

FIG. 5 is a first graphical user interface utilized by the system according to the present invention depicted in FIG. 1;

FIG. 6 is a second graphical user interface utilized by the system according to the present invention depicted in FIG. 1;

FIG. 7 is a first example of a summary report generated by the system according to the present invention depicted in FIG. 1;

FIG. 8 is a second example of a summary report generated by the system according to the present invention depicted in FIG. 1;

FIG. 9 is a third example of a summary report generated by the system according to the present invention depicted in FIG. 1;

FIG. 10 is a block diagram illustrating how backlog item data elements are managed and understood by a user of the system according to the present invention depicted in FIG. 1; and

FIG. 11 is a third graphical user interface utilized by the system according to the present invention depicted in FIG. 1.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, software development planning and management system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device.

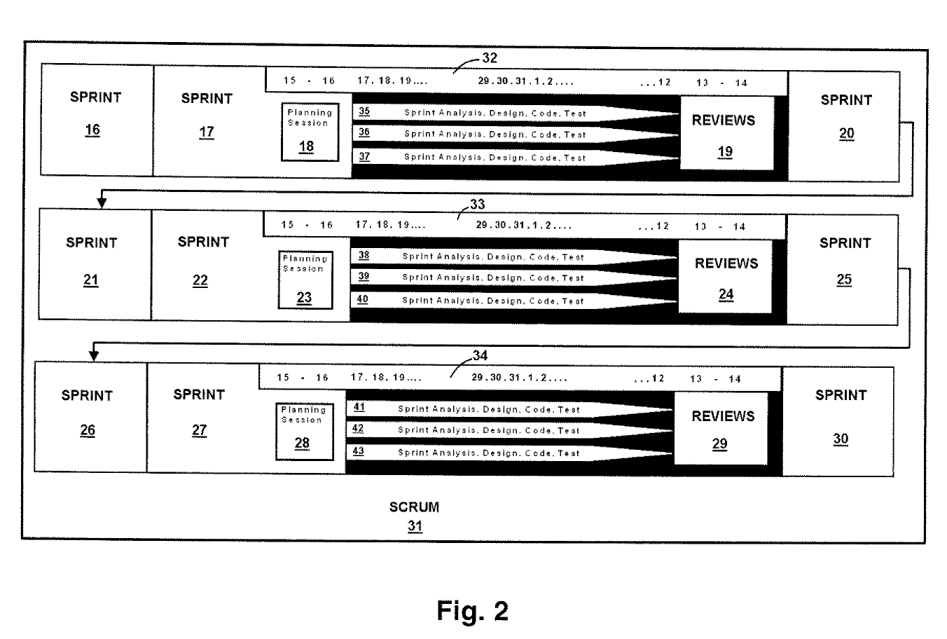

Referring to FIG. 2, the project cycles of a software product developed according to the principles of the present invention may be appreciated. The basic time unit of project development is the sprint period, such as, for example, sprint periods 16, 17, 20, 21, 22, 25, 26, 27 and 30. FIG. 2 depicts the activities occurring within a single scrum 31 which is comprised of the multiple successive sprints. A release is composed of multiple scrums and the final product is composed of multiple releases.

Sprint periods 17, 22 and 27 are shown in an expanded form to better describe the activities occurring during any particular sprint. Rows 32, 33 and 34 indicate the days of the month upon which particular sprint activities occur. While the sprints illustrated have a length of thirty days, the time period may be varied as necessary for a particular project. In the illustrated example, the sprints 17, 22 and 27 begin on the fifteenth day of the month with respective two day planning sessions 18, 23 and 28 during which the leader of the scrum 31 and the rest of the team plan the activities for the remainder of the sprint period. Any entities, such as teams 35, 36, 37, 38, 39, 40, 41, 42 and 43 that are utilized during the remainder of the sprint period are preferably involved in the planning sessions. The actual task analysis, design, code creation and testing is begun by the teams 35-43 on the seventeenth day of the month, with the work continuing until the twelfth day of the following month.

A review period, such as periods 19, 24 and 29, occurs on the thirteenth and fourteenth days of the month, at which time the functioning code completed during the preceding twenty nine days is demonstrated to the leader of new product development and introduction, as well as to the customer. The new product development leader must be available for the two day review period. Every sixth sprint period, such as sprint 25, is typically used as a stabilization sprint during which the cumulative effects of any prior requests for change are evaluated and integrated into the project.

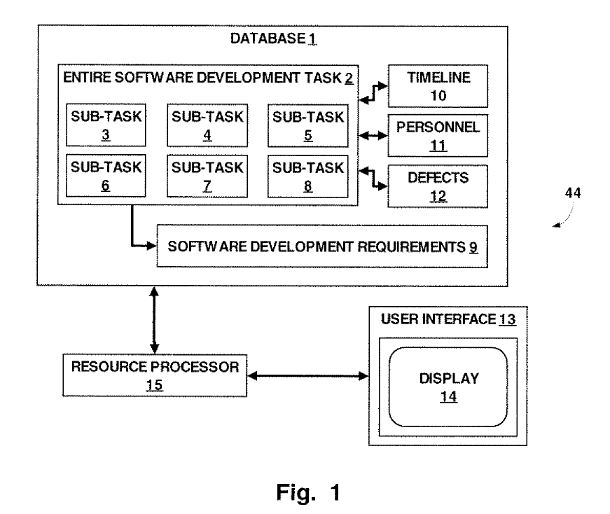

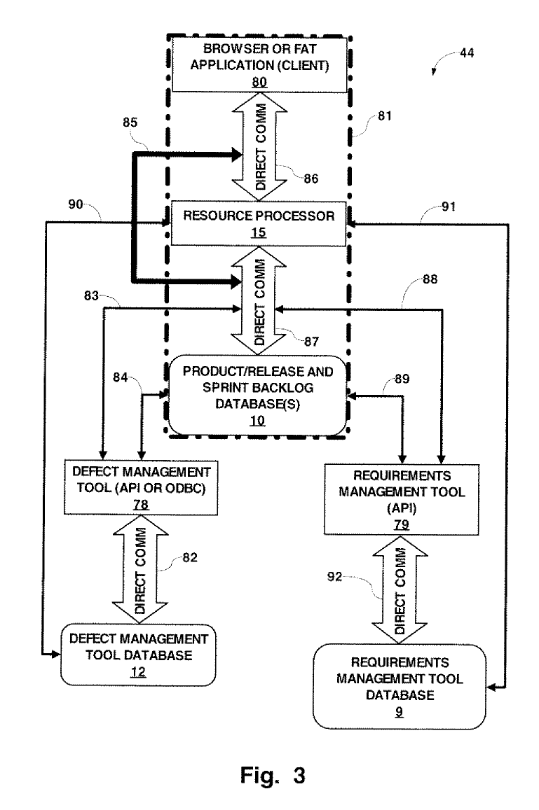

In general, the software development planning and management system 44 according to the present invention and illustrated in FIG. 1 and FIG. 3 includes at least one repository 1 of information. In the illustrated embodiment, the repository 1 may be implemented as a relational database. Data in the repository or repositories 1 associates sub-tasks 3-8 of an encompassing software development task 2 to be completed with a timeline 10 of sub-task completion, a programmer personnel resources 11, software development requirements 9 and software defects 12. The system 44 also includes a user interface 13, including a display device 14, which uses the repository or repositories 1 to provide data representing one or more display images which may be displayed on the display device 14. The display images indicate the status of sub-task completion, including the status of sub-task software generation and testing. A resource processor 15 uses the repository or repositories 1 to determine programmer personnel resources required for completion of the plurality of sub-tasks.

Such a system operates by identifying each software development task, decomposing each software development task into at least one sub-task, assigning relevant planning parameters to each sub-task, and relating at least a first sub-task to at least a second sub-task by means of at least one relevant planning parameter so as to determine at least one interdependency between the first sub-task and the second sub-task. Relevant planning parameters are stored within a relational database 1 (FIG. 1). A user interface to the relational database is created so as to permit user selection and modification of relevant planning parameters within the relational database. At least one display image accessible to a user is created via a user interface. The display image presents a graphical relationship between at least the first sub-task and the second sub-task. A display image may also be created which characterizes sub-tasks according to an effect on other sub-tasks. A display image may be created which visually codes sub-tasks according to a probability of completion according to a predetermined schedule. A textual report may also be created summarizing interrelationships between a plurality of sub-tasks.

Within each sprint period are a large number of interdependent factors and parameters that are constantly evolving. The system 44 according to the present invention, depicted in FIG. 1, includes a relational database 1 that is used to identify and manage the various interdependencies, including but not limited to a timeline 10, development requirements or specifications 9, personnel resources 11 and software defects 12 that extend across multiple product lines associated with the scrum 31 backlog items. A backlog item is a software development task 2, or sub-tasks 3-8 or a portion of a sub-task that is yet to be completed.

The relational database 1 receives data from several sources. The software requirements management database 9 includes requirements previously associated with an application release. An application programming interface (API) transfers data to the relational database 1 using a common numbering method to correlate software requirements to a sprint backlog item. The relational database 1 receives data regarding defects previously entered into the software defects database 12 using another API. The API dynamically associates defects with sprint projects using a common numbering method to correlate defects to a sprint backlog item. The relational database 1 also receives product/release work level items such as sub-tasks 3-8 from the sprint teams 35-43 using another API. The API dynamically associates work items with sprint projects using a common numbering method.

The database system 44 is capable of serving a number of users and interfacing with a number of other applications such as a browser or client application 80 (FIG. 3) in order to provide, for example, web based global access. The users and classes of users accessing the system 44 can expand or contract based on software development requirements. For example, in the illustrated embodiment, system 44 may accommodate on the order of one hundred additional concurrent users who are not physically located with the sprint team. Those personnel dispersed in different physical locations, time zones, and countries can use the system 44 as if they were virtually present at the sprint location.

Email notification of changes to an item based on a specified relationship such as a consumer/supplier or owner are also readily accommodated. Different levels of security access into the system 44 may be used to control access by persons to certain functions such as data entering, deletion or modification. The system 44 further records the change history of backlog item data records.

Referring to FIG. 3, the resource processor 15 and the client applications 80 can directly access the timeline/product/release/backlog database 10 in using the backlog management tool 81. Integration of the resource processor 15 and the system 44 may be accomplished with a discrete sprint backlog management tool 81 or the sprint backlog tool 81 may be implemented entirely within the functionality of the system 44. Similarly, integration with other tools for managing items such as requirements management 9 and defect management 12 may be accomplished with discrete management tools or the functionality may be incorporated entirely within the system 44.

While the resource processor 15 interacts directly, through communications links 87, 90 and 91, with the timeline or product/release/backlog database 10, the defects management database 12 and the requirements management database 9, respectively, each of the databases 9, 10 and 12 can also interact with a dedicated software tool via an appropriate API. For example, the defects management database 12 can access a defect management tool 78 which is capable of interacting with the defects database 12 directly either through an API or an open database connectivity (ODBC) compliant connection 82. Similarly, the requirements database 9 can directly access a requirements management tool 79 through connection 92. The timeline/product/release/backlog database 10 may interact with either management tool 78, 79 to update or synchronize data between the database 10 and tools 78, 79. The direct communications links 83 and 88 provide access to the data link 87 between database 10 and the resource processor 15, providing a means for the management tools 78 and 79 to coordinate, e.g. accelerate or retard, specific activities monitored and controlled by the backlog management tool 81. The communications path 85 provides a means for a client application 80 to directly access the management tools 78, 79 without interacting with the resource processor 15.

Referring again to FIG. 1, the system 44 includes a user interface 13 that provides access to various graphical user interfaces (GUIs) by means of a display 14 that generates a display image showing the assignment of items such as requirements, defects, and work items into releases including prioritization, estimation collection, release assignment, sprint sequence assignment and sprint team assignment. The display 14 includes user defined controls for accessing the input parameters.

The display 14 permits display of a graphical user interface (GUI), including at least one display image, allowing a user to enter data relating to the software development task 2 (FIG. 1). More specifically, the display image(s) enables a user to assign relationships between at least two of: (a) a sub-task, (b) a software defect, (c) a programmer, and/or (d) a group of workers. The display image(s) also enable a user to assign at least one of: (a) software requirements, (b) a sub-task, and (c) a defect, to a task and group of workers. This graphical user interface uses the repository database 1 in providing data representing at least one display image indicating the status of a sub-task completion, including the status of the sub-task software integration.

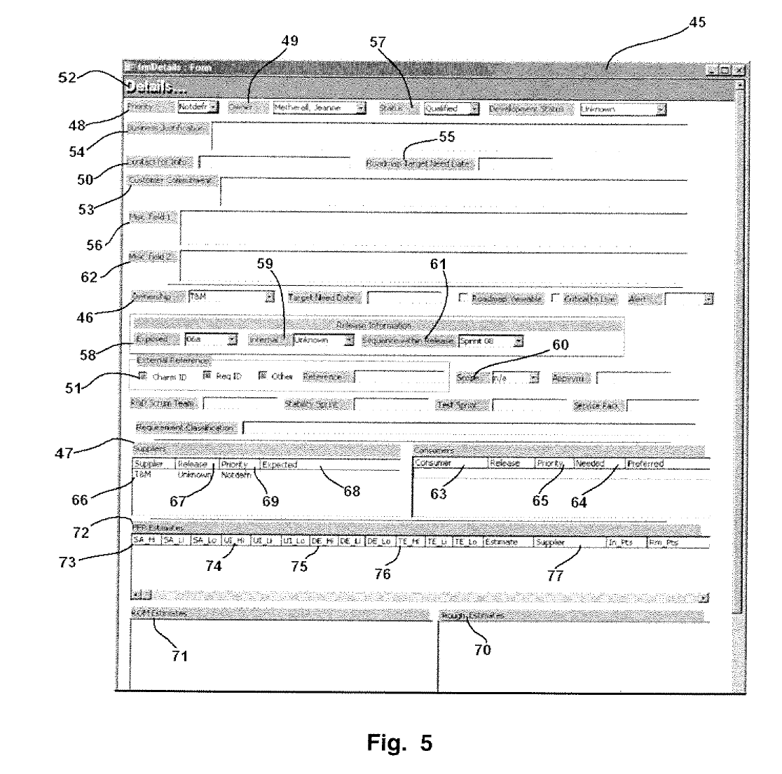

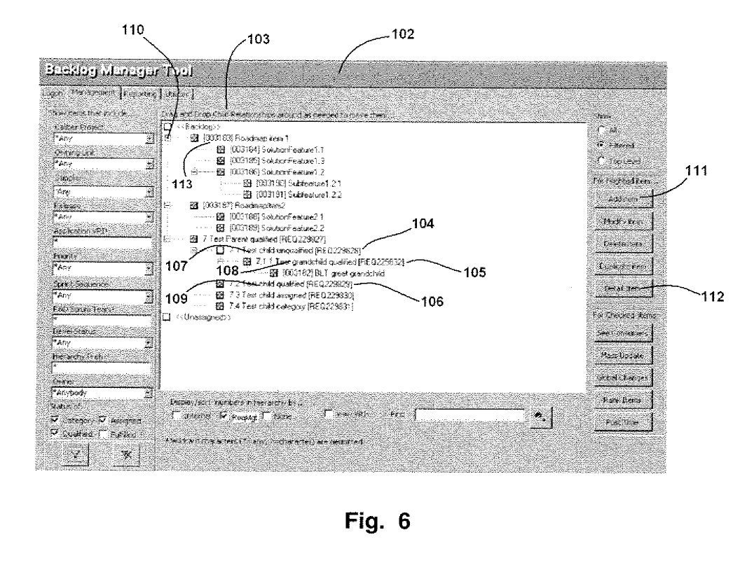

Referring to FIGS. 5 and 6, a first exemplary GUI 45 and a second exemplary GUI 102 are depicted. The GUI 45 permits assignment of the responsibility for various sprint related items to an owning group 46 and to associated suppliers 47, and provides the ability to edit input parameters derived from a user defined catalog. The GUI 45 may be used to assign product and team interdependencies according to each item, with editing options derived and validated from a user defined catalog. The display image 45 enables a user to assign a priority 48 to the plurality of subtasks and hence ranking of items based on editing options derived and validated from a user defined catalog.

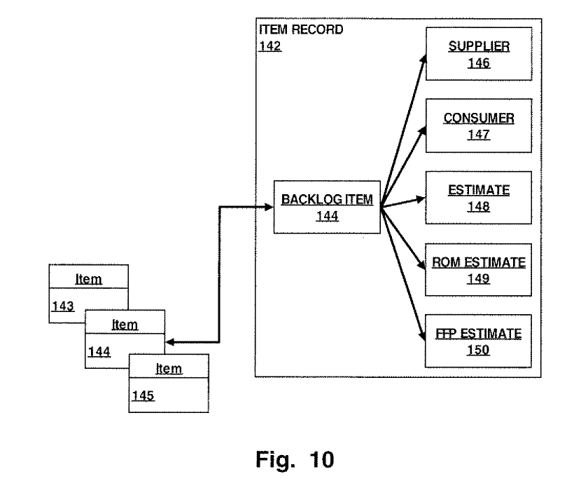

The database 1 (FIG. 1) includes backlog data elements that store attribute information for each backlog item as codes or coded text. Elements are recursively defined at each level of a hierarchy of the items. FIG. 10 summarizes the manner in which backlog item data elements contained within an item record 142 are managed and understood by the user. Each item 143, 144 and 145, for example, exists as part of a hierarchical relationship of items where a parent-child relationship is used in the decomposition of high-level, less detailed descriptions, e.g. for item 143, to create more detailed descriptions, e.g. item 144, followed by a yet more detailed description, e.g. item 145.

The item record 142 is created on the basis of a data element structure. The data element structure includes groupings of item attributes relating to a particular backlog item 144, for example. The data representing backlog item 144 includes attributes derived from the supplier data 146, consumer data 147, rough guess estimate data 148, rough order of magnitude estimate data 149 and firm fixed price estimate data 150. This data structure allows for one-to-many relationships of groupings of attributes for each backlog item 142.

Referring also to FIGS. 5 and 6, in general, a unique identification number 113 (FIG. 6) concerning the details 52 (FIG. 5) of backlog items. e.g. 143 (FIG. 10) includes the name, description, owner 49, owning unit 46, contact information 50, item entry source, the version of the item and the change history 51 of the item (FIG. 5). The database 1 (FIG. 1) iterates the relationship of an item to an application roadmap including the roadmap name, customer commitment 53, business justification 54, the target date 55 and the contact for information 50 (FIG. 5). The display image 45, and in particular the miscellaneous user field 56 (FIG. 5), enables a user of the system 44 to assign responsibility of the completion of a sub-task to (a) an individual worker or team member or (b) a group of workers or team members. The database 1 (FIG. 1) iterates product and release management attributes of an item including the target need date 55, status 57, priority 48, exposed release 58, internal release 59, rank, scoped for release 60, sequence within a release and miscellaneous user fields 56 and 62 (FIG. 5).

Within the database 1 (FIG. 1) each backlog item can have a one-to-many relationship to consumers, who are the internal users of the item, and the data regarding each relationship identifies the consumer 63, the target date of the consumer need 64, the consumer priority 65 and the consumer median priority (FIG. 5). Each backlog item can also have a one-to-many relationship to suppliers 47, who are the internal suppliers of the item, and each relationship includes identification of the supplier 66, supplier target release 67, supplier target need date 68 and the supplier priority 69 (FIG. 5).

Each backlog item can also have a one-to-many relationship with a rough guess estimate 70 (FIG. 5). The database 1 (FIG. 1) permits more than one estimate per item. Each rough guess estimate relationship includes a characterization such as a high, likely, or low probability estimate, and identifies the supplier, the entity making the estimate and the date of the estimate. Each backlog item can have a one-to-many relationship to a rough order of magnitude (ROM) estimate 71 (FIG. 5). More than one estimate per item is permitted. The relationship between the item and the estimate includes a probability (high, likely, low), supplier, estimating entity and estimate date. Each backlog item can potentially have a one-to-many relationship to firm fixed price (FFP) estimates 72 (FIG. 5). The database 1 (FIG. 1) permits more than one estimate per item. Each relationship includes the probability (high, likely, low) of an estimate for the total price, the systems analyst 73, the user interface 74, developer 75, tester 76 and supplier 77, and includes the estimating entity and the date of the estimate (FIG. 5).

The system 44 may also include a user interface for using the repository database 1 (FIG. 1) in providing data representing a hierarchically navigable display image or images which enable a user to determine status information of a task, sub-task and/or a portion of a subtask. Such a user interface indicates the status of completion of the task, sub-task and/or portion of the sub-task including the status of the task, sub-task and sub-task portion software generation and test. These hierarchically navigable display images enable a user to determine status information of a task, sub-task and/or portion of the sub-task, including the status of task, sub-task and sub-task portion software integration. These hierarchically navigable display images further enable a user to assign a priority to the plurality of sub-tasks. These hierarchically navigable display images also enable a user to assign relationships between at least two of: (a) sub-task, (b) a software defect, (c) a programmer, and/or (d) a group of workers. The resource processor 15 (FIG. 1) uses the repository database 1 in determining the programmer personnel resource required for completion of the plurality of sub-tasks.

The hierarchically navigable display images also enable a user to assign at least one of: (a) software requirements, (b) a sub-task, and (c) a defect, to a task and group of workers. In this case, the user interface uses the repository database 1 (FIG. 1) in providing data representing at least one display image indicating the status of sub-task completion, including the effect of delinquent sub-task completion on other uncompleted sub-tasks.

Referring also to FIG. 6, a second product/release management interface GUI 102 is illustrated that depicts, in a hierarchical tree representation 110, the parent items and the child relationships 103 resulting from the decomposition of the items into more detailed items, as described above. Items from the requirements management system 9 (FIG. 1) are indicated by a requirements (REQ) number such as REQ numbers 104, 105 and 106, for example, appearing next to the item name 107, 108 and 109, respectively, within the tree structure 110 (FIG. 6). A product manager may use the GUI 102 (FIG. 6) to process an approved customer request to add a feature to the items already in the backlog. An item may be added via button 111. Details concerning the item may be created by selecting button 112 which opens GUI 45 (FIG. 5) and permits creation of a rough guess estimate of the effort, priority, and information on the customer's expectations regarding the date that the requested feature should be available. The product manager, release manager, and others are then in a position to evaluate the request for insertion into a subsequent release using a needs assessment analysis method. Initially the requested feature is described in terms of high level requirements which are eventually decomposed by the requirements analyst into detailed requirements that are entered into the requirements database 9 (FIG. 1). The backlog/timeline database 10 (FIG. 1) receives the requirements by means of the API 79 (FIG. 3) so that the detailed information resides in the backlog management tool 81 (FIG. 3) for subsequent insertion into releases and assignment to individual sprint teams, an individual team member or a group of team members.

Given the numerous user inputs just described, the resource processor 15 (FIG. 1) is able to generate numerous types of output data including release information for planning or status purposes. The input estimate data 70-77 (FIG. 5) permits the resource processor 15 to calculate estimation information by business unit, application unit, release number, sprint sequence, and sprint team. Interdependency information is also available from the resource processor 15 by business unit, application unit, release, sprint sequence, and sprint team, as well as the affected interdependencies that are created as the result of schedule changes. Alert information is generated by processor 15 to notify the user of changed item parameters that are related to a team by ownership or interdependency, as well as alert information regarding items that are at risk of not being completed as expected.

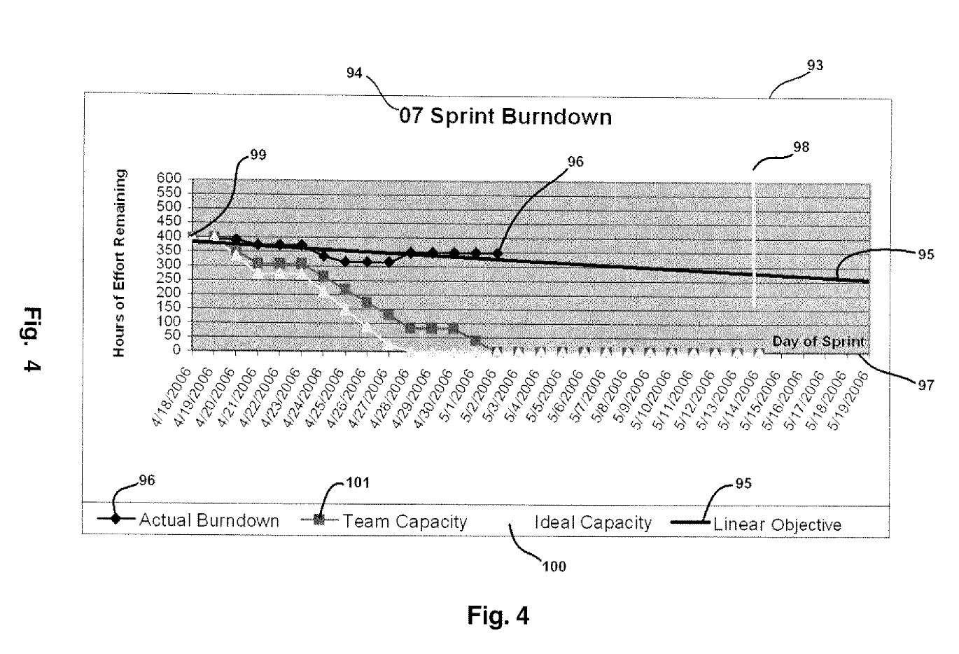

The processor 15 (FIG. 1) determines the consumption of resources used to build and test requirements in relationship to the time needed to accomplish the tasks defined by a particular sprint period. The system 44 (FIG. 1) calculates the use of sprint resources by subtracting the sprint total estimated time from the time used. This resource calculation is expressed in a time measurement called burn down, as illustrated in FIG. 4 The burn down data is displayed as a graphical burndown chart 93 for each day 97 before the end 98 of the sprint period. Both the sprint total estimated time and the time actually used are derived from the relational database 1 (FIG. 1) by using the identification number 94 associated with a particular sprint. Once calculated, the database 1 compares the actual burn down result 96 with the previously assigned linear schedule objective 95. Multiple tasks associated with a sprint are summarized to provide a total amount of time 99 required to complete the tasks in a particular sprint 94.

The resource requirements of ideal capacity 100 and actual team capacity 101 are derived by adding together the personnel resources for the number of sprint tasks to be performed, and subtracting that total from the current estimate of resources which is derived from previously submitted estimates. A release manager planning the development requirements for the next release is able to assign a number of backlog items to the release and the system 44 (FIG. 1) calculates the total estimated time necessary to develop those items. The burndown chart 93 displays the capacity calculations for the teams assigned to the selected items so that the release manager can determine whether the teams have sufficient capacity to accomplish the work. Multiple iterations which add sprint teams or reduce features may be performed to establish an estimate for the complete release.

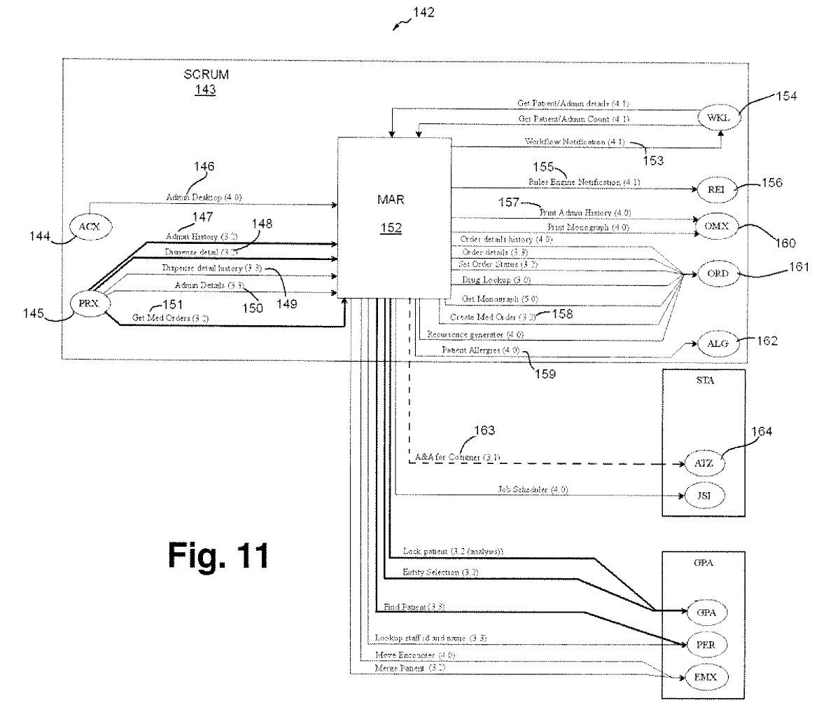

Referring also to FIG. 11, another graphical user interface 142 is depicted which supplements the information shown in the burndown chart 93. The GUI 142 facilitates the management of products and releases in a single, cross-unit environment and provides early visibility of cross-unit dependencies and potential resource conflicts. The depiction provided by GUI 142 facilitates impact analysis of product change requests by using capacity and estimates to view item dependencies. The GUI 142 consolidates reporting of feature/roadmap and release development status. Within GUI 142 each sprint or project is tracked according to product requirement estimates and compared to actual work done as expressed in terms of time or units of work for a particular sprint, as was done with the sprint burndown GUI 93 (FIG. 4).

The status of a scrum 143 may be viewed along with the activities occurring outside of a particular serum. In this example, the GUI 142 shows two suppliers 144 (ACX) and 145 (PRX). Supplier ACX 144 has a single task 146 and supplier PRX 145 has a plurality of tasks 147, 148, 149, 150 and 151 that they are working on for a particular project 152 (MAR). The lines used to interconnect the various tasks from supplier to project are coded to indicate the status of the task. The lines may be color coded, weighted, or otherwise differentiated to indicate the meaning to be attached to the line. In the illustrated embodiment, the line width associated with tasks 146, 149 and 150 indicates that those tasks will delay work on project 152 because their schedule or timeline has already been missed. The result of the delays imposed by tasks 146, 149 and 150 propagates through the remainder of the GUI 142. For example, the line width of the task 153 indicates that task 153 will affect commitments to customer 154, and the task 155 will adversely affect customer 156. Similarly, each task represented with the given line weight or color for tasks 157, 158 and 159 will adversely affect the customer 160, 161 and 162, respectively. The GUI 142 shows a product manager that the initial tasks 146, 149 and 150 will delay the sprints of customers 154, 156, 160, 161 and 162 unless there is a reallocation of competent resources or a reduction in the scope or function of requirements for the sprints associated with project 152 if the schedules of the customers are to be met.

The GUI 142 includes other variations that are of use to a manager. The line width or color associated with tasks 147, 148 and 151 indicate that the schedule for those tasks is likely to be missed. In the example shown, only the task 163, indicated by a broken line or a different color, is on schedule and thus customer 164 will receive their software on time. Each sprint/project is tracked according to product requirement estimates as compared to actual work done as expressed in terms of time or units of work for a sprint.

In addition to the various GUI presentations, the data gathered and processed by the system 44 (FIG. 1) permits the generation of summary reports. The summary reports give a user the ability to manage many estimates from a requirement supplier in order to facilitate the scaling and scoping of a release, to view requirements per consumer, per supplier, per release or per hierarchy, and to mass maintain the attributes of a requirement such as target release.

The summary reports, as well as the GUls, may be customized as needed to serve the purposes of a particular manager. In addition to the examples already given, a report or GUI may be customized to emphasize a project view, a release view, a consumer dependencies view, a supplier dependencies view, a changed items view, a release estimate versus capacity view or a customer view. The summary reports are helpful in managing large, dynamic backlogs by providing a list of work in relation to the stipulated criteria when a change of work effort or scope is proposed.

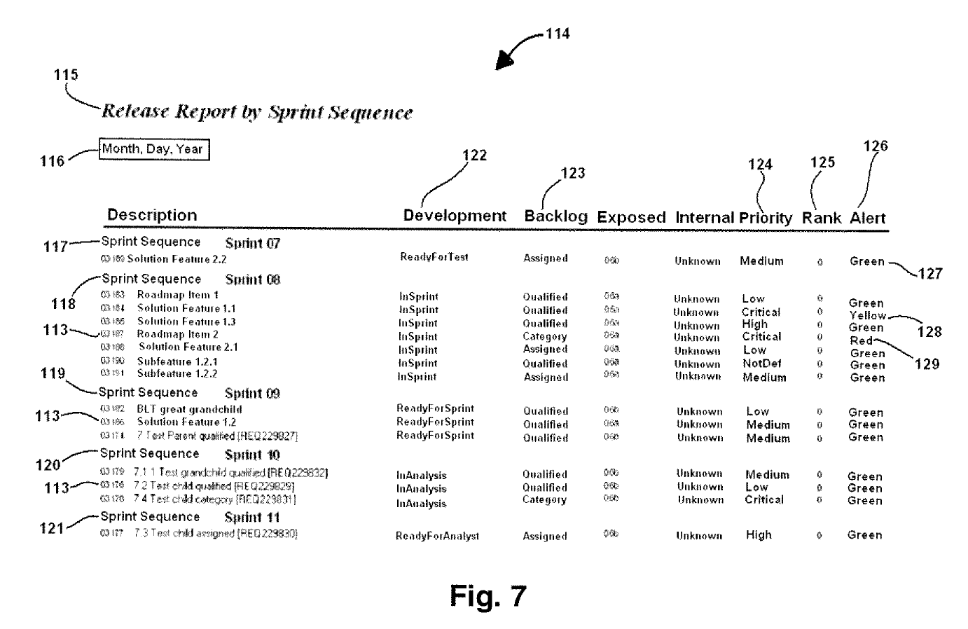

An example of a summary report 114 generated by the system 44 (FIG. 1) and available to the user via display 14 is depicted in FIG. 7. The example report includes a descriptive title 115 and is a summary of characteristics of each release item by identification number 113 as of the report date 116. The report 114 identifies each sprint sequence 117, 118, 119, 120 and 121 and includes a status report for each item in the sprint. Column 122 lists the development status of each item while column 123 gives the backlog work status of each item. Column 124 gives the item priority, column 125 states the item rank and column 126 lists the item alert status. A green alert status 127 indicates that the sprint item is proceeding according to plan. A yellow alert status 128 indicates that the item has probable cause for delay, while a red alert status 129 indicates the project may be endangered by the item.

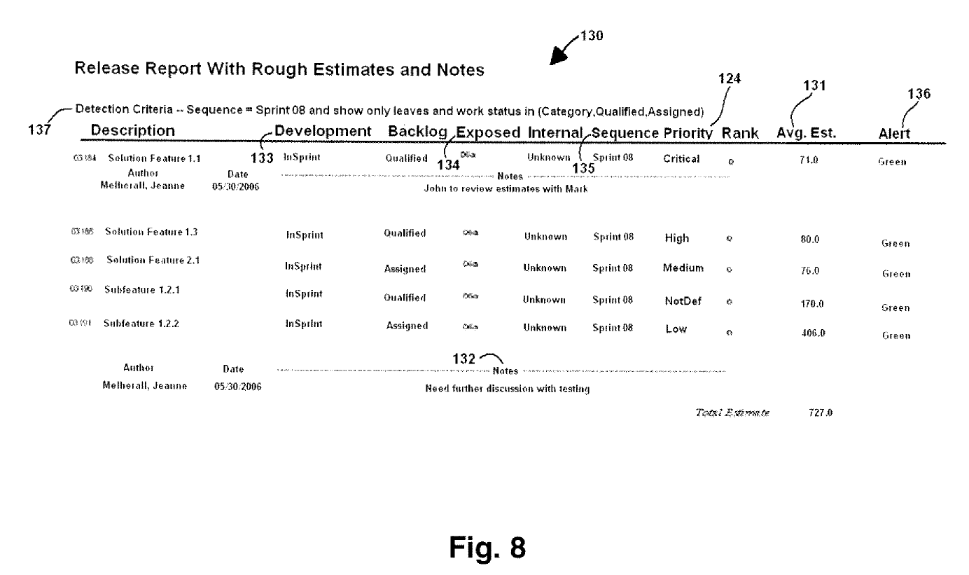

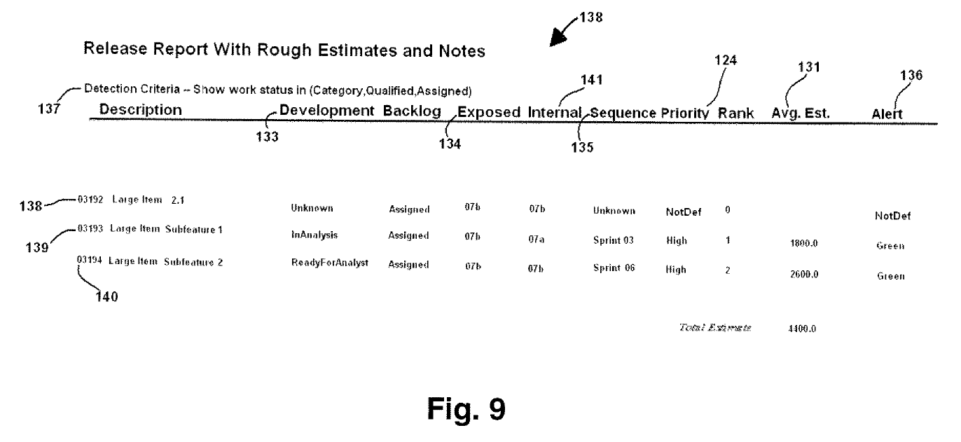

An example of a release report 130 is depicted in FIG. 8. The release report 130 includes rough estimates 131 and notes 132 for sprint number eight of a release. Report 130 includes development status 133, release information 134, sprint sequence information 135 and alert status 136. As seen in FIG. 9, a second release report 138 permits the managers to inspect only those items that have been qualified or assigned and so set the detection criteria 137 to list only those items. The release report may be utilized, for example, by a product manager and a release manager who are studying the backlog items for their team for the upcoming next three development efforts. There is an item 139 in the backlog that is not needed for eighteen months but is large and may take significant resources to build, as evidenced by the estimate in column 131. The item 139 is scheduled for release 07b as seen in column 134, where the “exposed” heading indicates the number of the release that will be made available to the customer. The larger item 139 has been decomposed into two subitems 140a and 140b. The build for subitem 140a is scheduled during release 07a, as indicated in column 141, where the heading “internal” signifies the release in which functionality is complete but the release is not yet available to the customer. Subitem 140a is not exposed until subitem 140b is completed in exposed release 07b. The release report 138 aids the managers in their decision to split the effort for item 139 into two development rounds so that a portion of the needed programming will be completed in the next two releases and finalized in the third release.

Although the preferred embodiments for the invention have been described and illustrated, the specific charts and user interfaces are exemplary only. Those having ordinary skill in the field of data processing will appreciate that many specific modifications may be made to the system 44 described herein without departing from the scope of the claimed invention.

What is claimed is:

1. A software development planning and management system, comprising:
at least one repository of information associating, sub-tasks of an encompassing software development task to be completed and a timeline of sub-task completion, programmer personnel resources, software development requirements, and software defects;
a user interface for using said at least one repository in providing data representing at least one display image indicating status of sub-task completion including status of sub-task software generation and test; and
a resource processor for using said at least one repository in determining programmer personnel resources required for completion of a plurality of sub-tasks.

2. A system according to claim 1, wherein said at least one display image enables a user to assign responsibility of completion of a sub-task to at least one of, (a) an individual worker and (b) a group of workers.

3. A system according to claim 1, wherein said at least one display image enables a user to assign priority of said plurality of sub-tasks.

4. A system according to claim 1, wherein said at least one display image enables a user to assign relationships between at least two of: (a) a sub-task, (b) a software defect, (c) a programmer, and (d) a group of workers.

5. A system according to claim 1, wherein said at least one display image enables a user to assign at least one of : (a) software requirements, (b) a sub-task, and (c) a defect, to a task and group of workers.

6. A system according to claim 1, wherein said user interface uses said at least one repository in providing data representing at least one display image indicating status of sub-task completion including status of sub-task software integration.

7. A software development planning and management system, comprising:
at least one repository of information associating, sub-tasks of an encompassing software development task to be completed and a timeline of sub-task completion, programmer personnel resources, software development requirements, and software defects; and
a user interface for using said at least one repository in providing data representing hierarchically navigable display images enabling a user to determine status information of a task, sub-task and portion of a sub-task indicating status of completion of said task, sub-task and portion of said sub-task including status of task, sub-task and sub-task portion software generation and test.

8. A system according to claim 7, further comprising a resource processor for using said at least one repository in determining programmer personnel resources required for completion of a plurality of sub-tasks.

9. A system according to claim 7, wherein said hierarchically navigable display images enable a user to determine status information of a task, sub-task, and portion of a sub-task indicating status of completion of said task, sub-task and portion of said sub-task including status of task, sub-task and sub-task portion software integration.

10. A system according to claim 9, wherein at least one of said hierarchically navigable display image enables a user to assign priority of said plurality of sub-tasks.

11. A system according to claim 10, wherein at least one of said hierarchically navigable display image enables a user to assign relationships between at least two of: (a) sub-task, (b) a software defect, (c) a programmer, and (d) a group of workers.

12. A system according to claim 11, wherein at least one of said hierarchically navigable display image enables a user to assign at least one of: (a) software requirements, (b) a sub-task, and (c) a defect, to a task and group of workers.

13. A system according to claim 12, wherein said user interface uses said at least one repository in providing data representing at least one display image indicating status of sub-task completion including an effect of delinquent sub-task completion on other uncompleted sub-tasks.

14. A method of planning and managing software development tasks, comprising:
identifying each software development task;
decomposing each software development task into at least one sub-task;
assigning relevant planning parameters to each sub-task; and
relating at least a first sub-task to at least a second sub-task by means of at least one relevant planning parameter so as to determine at least one interdependency between the first sub-task and the second sub-task.

15. The method of claim 14, further comprising storing each relevant planning parameter within a relational database.

16. The method of claim 15, further comprising creating a user interface to the relational database so as to permit user selection and modification of relevant planning parameters residing within the relational database.

17. The method of claim 16 further comprising creating at least one display image accessible to a user via the user interface, the display image presenting a graphical relationship between at least the first sub-task and the second sub-task.

18. The method of claim 17 further comprising the step of creating a textual report summarizing interrelationships between a plurality of sub-tasks.

19. The method of claim 18 further comprising creating a display image that characterizes sub-tasks according to an effect on other sub-tasks.

20. The method of claim 19 further comprising creating a display image that visually codes sub-tasks according to a probability of completion according to a predetermined schedule.
